(19) United States
(12) Patent Application Publication
(10) Pub. No.: US 2008/0314042 A1
(43) Pub. Date: Dec. 25, 2008

(54) Stationary combustion engine

(76) Inventors: Rainer Greuter, Wattens (AT); Johann Hirzinger, Kossen (AT); Johann Klausner, St. Jakob i.H. (AT)

Correspondence Address: WENDEROTH, LIND & PONACK, L.L.P., 2033 K STREET N. W., SUITE 800, WASHINGTON, DC, 20006-1021, US

(21) Appl. No.: 12/213,544

(22) Filed: Jun. 20, 2008

(30) Foreign Application Priority Data
Jun. 20, 2007 (AT) A 955/2007

(51) Int. Cl. F02D 23/00

(52) U.S. Cl. 60/602; 60/624; 123/350; 290/1 A

(57) ABSTRACT

A method of operating a stationary internal combustion machine (1), in particular a gas engine, comprising a compressor device (2) which compresses gas (5, 6) fed to the internal combustion machine (1), and a throttle device (7) which is connected downstream of the compressor device (2) and with which the amount of compressed gas (5, 6) fed to the internal combustion machine is variable, wherein the compressor device (2) is operated by way of an exhaust gas turbine (3) of variable turbine geometry, wherein the internal combustion machine (1) is regulated to a substantially constant engine regulating value by way of the actuation of at least two adjusting members, wherein upon a deviation in the engine regulating value from a reference value the amount of gas fed to the internal combustion machine (1) is altered by the actuation of the throttle device (7) as the first adjusting member and by the variation in the geometry of the exhaust gas turbine (3) as the second adjusting member so that the engine regulating value is re-set to the reference value; regulating device and internal combustion machine for carrying out the method.

The invention concerns a method of operating a stationary internal combustion machine, in particular a gas engine, comprising a compressor device which compresses gas fed to the internal combustion machine, and a throttle device which is connected downstream of the compressor device and with which the amount of compressed gas fed to the internal combustion machine is variable, wherein the compressor device is operated by way of an exhaust gas turbine of variable turbine geometry, wherein the internal combustion machine is regulated to a substantially constant engine regulating value by way of the actuation of at least two adjusting members. The invention further concerns a regulating device for a stationary internal combustion machine for carrying out a method of the aforementioned kind. Finally the invention concerns a stationary internal combustion machine, in particular a gas engine, having such a regulating device and a generator operable by such an internal combustion machine.

In order to regulate an engine regulating value such as power output or rotary speed in the case of an internal combustion machine such as an internal combustion engine, in particular a stationary gas engine, in most cases there are a plurality of adjusting members on the internal combustion machine. Primarily the throttle valve in the induction tract is actuated as the adjusting member. In the case of a forced-induction internal combustion machine it is possible for the power output or rotary speed to be additionally influenced for example by way of a controllable valve (blow-off valve) as a second adjusting member which is arranged parallel to the compressor in the induction tract of the internal combustion engine. EP 0 757 169 B1 proposes for example a regulating system in which the engine regulating value is regulated in different operating states at different power outputs or rotary speeds by way of displacement of a respective adjusting member. In that case there is only ever one respective adjusting member that is displaced by an associated regulator while the other adjusting member is held in a fixed position. In specific terms EP 0 757 169 B1 proposes, as respective adjusting members for regulating the engine parameter, altering the throttle valve position and the opening of the blow-off valve. Such a regulating system is proven to be advantageous in operation in different operating states.

Frequently, stationary internal combustion machines of the general kind set forth are used for generating electric power in the isolated mode of operation or in the emergency power mode or for mains parallel operation mode. In dependence on the respective mode of operation it is necessary for the output power or the rotary speed of the internal combustion machine to be kept constant. The susceptibility to trouble and the increasing sensitivity of the electrical device driven directly or indirectly by such an internal combustion machine make it necessary for the respective engine parameter to be kept constant with a very high level of precision even in fluctuating situations. Fluctuating situations can occur for example due to disturbance influences or changes in load.

The object of the present invention is therefore that of providing a method and devices of the general kind set forth in the opening part of this specification, with which it is possible to achieve a higher level of regulating accuracy to a constant engine regulating value, preferably rotary speed or power output.

That object is attained by the independent claims.

The corresponding method of operating a stationary internal combustion machine, in particular a gas engine, comprising a compressor device which compresses gas fed to the internal combustion machine, and a throttle device which is connected downstream of the compressor device and with which the amount of compressed gas fed to the internal combustion machine is variable, wherein the compressor device is operated by way of an exhaust gas turbine of variable turbine geometry, wherein the internal combustion machine is regulated to a substantially constant engine regulating value by way of the actuation of at least two adjusting members, is characterised in that upon a deviation in the engine regulating value from a reference value the amount of gas fed to the internal combustion machine is altered by the actuation of the throttle device as the first adjusting member and by the variation in the geometry of the exhaust gas turbine as the second adjusting member so that the engine regulating value is re-set to the reference value.

A corresponding regulating device for a stationary internal combustion machine comprising a compressor device operable by way of an exhaust gas turbine of variable geometry and a throttle device which regulates an engine regulating value to a substantially constant reference value, wherein at least two adjusting members can be influenced by way of the regulating device, is characterised in that in the operating state upon a regulating deviation of the engine regulating value from the reference value the amount of gas fed to the internal combustion machine can be regulated by way of the regulating device by the position of the throttle device as the first adjusting member and the geometry of the exhaust gas turbine as the second adjusting member being variable.

A stationary internal combustion machine, in particular a gas engine, comprising a compressor device for compressing gas fed to the engine and a throttle valve disposed downstream of the compressor device for quantitative limitation of the compressed gas fed to the internal combustion machine, wherein the compressor device is operable by way of an exhaust gas turbine of variable turbine geometry, is characterised by a regulating device as set forth hereinbefore, which in the operating state regulates the internal combustion machine to a substantially constant engine regulating value by way of the alteration of at least two adjusting members, by the regulating device actuating the throttle device as the first adjusting member and altering the geometry of the exhaust gas turbine as the second adjusting member. The term disposed downstream is used in the context of the disclosure to denote that the corresponding feature is arranged downstream of the flow of gas in the exhaust direction.

The invention is based on the idea of using two adjusting members for the regulation operation, with which the amount of gas fed to the internal combustion machine is rapidly directly variable. One advantage of the invention is also that no additional volumes due to by-pass lines have to be introduced into the induction tract, which would involve a regulating delay. The system acts on the amount of gas fed to the internal combustion machine immediately and directly both by virtue of the change in the geometry in the exhaust gas turbine and also by virtue of the throttle valve position.

Further details and advantages of the invention will be apparent from the dependent claims.

For the method it can be provided in particular that the internal combustion machine operates a generator. In that case—particularly in the isolated mode of operation or in the emergency power mode of operation—it is preferably provided that the generator is regulated at a constant rotary speed and thus at a fixed frequency so that the risks of damage to sensitive terminal devices is minimised.

In the mains network parallel mode of operation it is particularly advantageously provided that the internal combustion machine is regulated to a constant power output. In that case for example in the generator mode a constant amount of power is always fed into the mains network.

As an advantageous regulating characteristic, it has proven to be desirable if the geometry of the exhaust gas turbine is altered only upon a regulating deviation of the regulating value from the reference value of at least 5%. In that case, in the event of minor fluctuations regulation is still effected only by way of the throttle valve while in the event of more severe fluctuations the exhaust gas turbine geometry is additionally altered. Thus for example in the case of major jumps in load, the system can provide for rapidly regulating to the constant engine regulating value while in the case of slight regulating deviations re-regulation solely by actuation of the throttle valve is sufficient. It is preferably provided that the gas flowing to the throttle device is cooled. In a particularly preferred variant it is further provided that the gas fed to the compressor device is a fuel/air mixture. In contrast to many conventional compressor devices in which the compressed gas substantially consists of compressed air which is fed directly to the engine, with a fuel being simultaneously injected into the engine, it is advantageous in relation to gas engines to already produce a fuel/air mixture before compression in order to increase the power output.

In a regulating device according to the invention it is advantageous if the engine regulating value is the power or the rotary speed. In that respect it has proven to be desirable if the regulating device is so designed that the change in the geometry of the exhaust gas turbine is effected in subordinate relationship. In particular it is desirable if the regulator characteristics of the at least two regulators are such that the change in the geometry of the exhaust gas turbine is subordinate to the influencing of the position of the throttle device. A subordination relationship can be effected for example by means of a suitable regulator characteristic, for example by a suitable integral portion in the case of a PID-regulator or by upstream connection of a dead band. It has therefore proven to be advantageous if a respective regulator is associated with the two adjusting values. The advantageous variant provides that the regulating device is so designed that it actuates only the throttle device upon a deviation of the engine regulating value of below 5% from the reference value. It can further be provided that the regulating device has at least one PID-regulator and an adjusting value limitation is associated with the regulating device for at least one adjusting value and at least one regulator has a dead band for delaying the adjusting value intervention.

A stationary internal combustion machine of the general kind set forth in the opening part of this specification is advantageously designed in accordance with the invention if a generator is operable with the internal combustion machine, in which case then the engine regulating value could be a constant rotary speed of the internal combustion machine. That is advantageous for what is referred to as the mains network parallel mode of operation of the generator. It can further be provided that a generator is operable with the internal combustion machine, wherein the regulating value is a constant power output of a generator. That is desirable for the island mode of operation or the emergency power mode of operation of the generator.

It is desirably provided that disposed between the compressor device and the throttle device is a cooling device with which the gas flowing to the throttle device can be cooled.

The invention further concerns a generator with an internal combustion machine as set forth hereinbefore and a regulating device as set forth hereinbefore for the internal combustion machine.

Further details and advantages of the invention will be described in the specific description and with reference to the diagrammatic drawings in which:

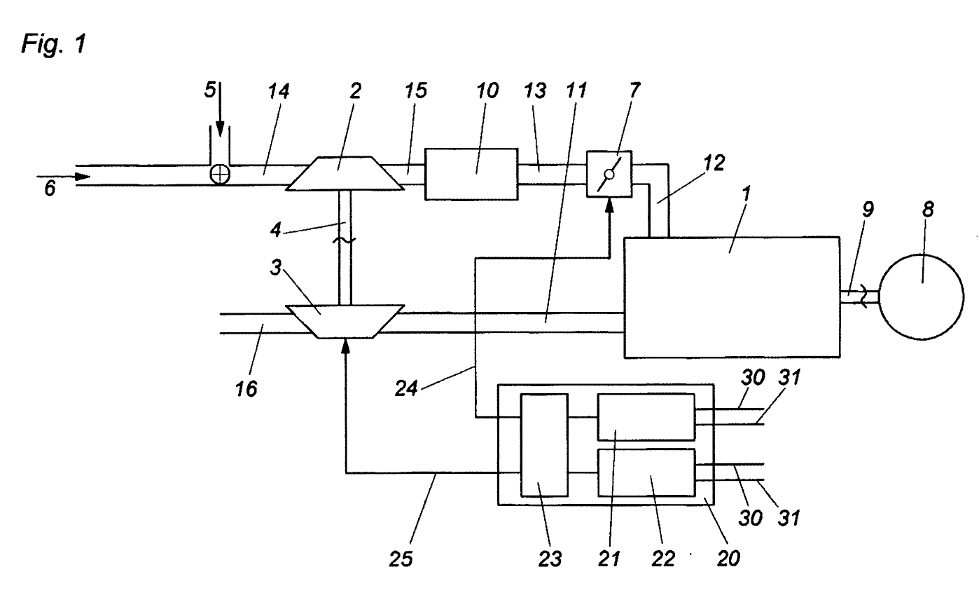

FIG. 1 diagrammatically shows an embodiment of an internal combustion machine according to the invention with generator,

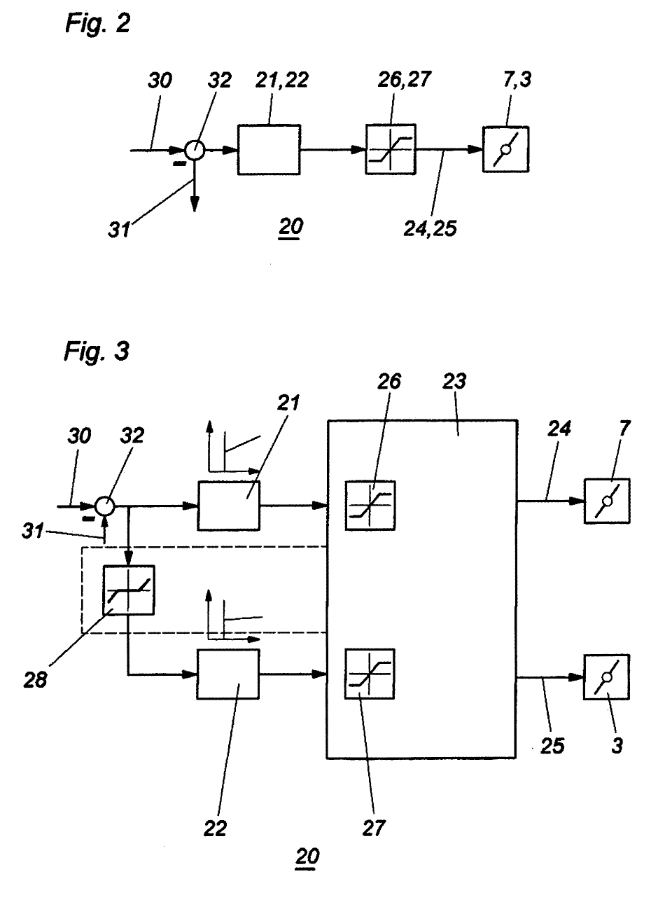

FIG. 2 is a diagrammatic and greatly simplified view of an embodiment of a regulating device according to the invention, and

FIG. 3 shows an embodiment of a regulating device according to the invention.

FIG. 1 shows a stationary internal combustion machine 1. The illustrated embodiment represents a gas engine. The internal combustion machine 1 is fed with air 5 and fuel 6, by the air 5 and the fuel 6 in gas form being mixed at the node point (the node point thus forms a mixing device). The air 5 and the fuel 6 form a gas mixture which is fed to the compressor device 2 by way of the line 14. The compressor device 2 is connected by way of a shaft 4 to an exhaust gas turbine 3 arranged in the exhaust tract 11 of the internal combustion machine 1 and is operated by way of the exhaust gases from the internal combustion machine 1. The exhaust gas turbine is of a variable turbine geometry in accordance with per se known state of the art. By way of example, vanes or blades are arranged in the exhaust gas turbine 3, which are actuable by an actuator (not shown) and thus alter the position in the exhaust gas turbine 3. In that way the flow of gas in the exhaust gas turbine 3 can be altered, whereby the compressor device 2 which is driven directly by way of the shaft 4 by the exhaust gas turbine 3 is rotated at an altered speed so that this involves greater or lesser compression of the gas (here air 5 and fuel 6 mixture). The fuel/air mixture which is now compressed (compressed gas in accordance with the claim) is fed to a cooling device 10 by way of the line 15 connected downstream of the compressor device 2 as the compressed fuel/air mixture is greatly heated by being compressed. Connected downstream of the cooling device 10 is a line 13 which leads to the throttle device 7 (throttle valve) which regulates the amount of fuel/air mixture to the internal combustion machine 1 by way of the line 12. In accordance with EP 0 757 169 B1 a by-pass line with valve (blow-off valve) with which the amount of mixture can also be regulated would be disposed between the line 13 (which is arranged between the compressor device 2 and the throttle valve 7 and which in the illustrated embodiment is also disposed downstream of the optional cooling device 10) and the line 14. In the device according to the invention it would be possible to dispense with such a by-pass line.

The illustrated internal combustion machine 1 drives a generator 8 by way of a shaft 9. The actual regulating device is identified by reference 20. The regulating device 20 has two regulators 21, 22. In that case the regulator 21 is associated with the throttle valve 7 (throttle valve regulator 21). The regulator 22 is associated with the adjusting member for varying the geometry at the exhaust gas turbine (VTG regulator 22). For example an actuator for actuating the blades or vanes. The engine regulating value 30 (detected for example by sensors), preferably power output or rotary speed, is fed to both regulators 21, 22. The respective reference value 31 is fed both to the throttle valve regulator 21 and also to the VTG regulator 22. The respective regulators 21, 22 form the regulating deviation by comparison of the actual value of the engine regulating value 30 with the reference value 31. The respective regulator 21, 22 ascertains therefrom a corresponding signal which acts on the regulating section by way of the corresponding setting member (throttle valve 7 or means for varying the geometry of the exhaust gas turbine 3) and which counteracts the regulating deviation. The corresponding signal is fed to the corresponding adjusting members 7, 3 by way of the lines 24, 25. In the illustrated embodiment there is also a linking device 23 so that the two regulators 21, 22 are matched to each other and it is only upon a corresponding regulating deviation that both or only one adjusting member 7, 3 is influenced as described hereinbefore.

FIG. 2 is a diagrammatic view showing the regulating device 20 once again. The difference between the reference value 30 and the actual value 31 is formed at the linking point 32 and fed to the regulator 21 or 22. The regulators can be for example in the form of PID regulators or PI regulators. It will be appreciated that other regulators are also possible. The engine regulating value is re-set for example with a PID regulator from the corresponding regulating deviation, by a procedure whereby the corresponding adjusting members 7, 3 are actuated with a signal by way of the signal lines 24, 25. So that no ‘over-regulation’ occurs, linked to damage to or an adverse effect on the internal combustion machine 1, adjusting value limiters 26, 27 can also be connected at a downstream location so that the throttle valve 7 can only be opened to a maximum value of for example 30%. Similarly the corresponding means for altering the geometry of the exhaust gas turbine 3 can be correspondingly limited.

FIG. 3 shows a preferred embodiment illustrating how a corresponding regulating device 20 could look in practice. At the linking point 32 the reference value 30 is compared to the actual value 31 and the corresponding signal passed to the throttle valve regulator 21 and the VTG regulator 22. Connected upstream of the VTG regulator is a dead band 28 so that that regulator can come into operation with a delay. By way of example a delay of fractions of a second could be provided in order not to cause excessive regulation, with an only very short fluctuation in the engine regulating signal. The regulator characteristic of the two regulators 21, 22 is also correspondingly different, as indicated in the diagrams illustrated above the regulators 21, 22. In the example the throttle valve regulator 21 is a PID regulator with a steeper integral portion than the VTG regulator 22 so that as a result regulation is effected more strongly by way of the throttle valve 7 than by way of the change in geometry of the exhaust gas turbine 3. Connected downstream of the two regulators 21, 22 is a logic means 23 which represents an adjusting value limitation 26 and 27 respectively for the respective adjusting value so that, for safety reasons, an excessively great adjusting signal is not passed from the regulator output to the throttle valve 7 or the exhaust gas turbine 3.

1. A method of operating a stationary internal combustion machine comprising a compressor device which compresses gas fed to the internal combustion machine, and a throttle device which is connected downstream of the compressor device and with which the amount of compressed gas fed to the internal combustion machine is variable, wherein the compressor device is operated by way of an exhaust gas turbine of variable turbine geometry, wherein the internal combustion machine is regulated to a substantially constant engine regulating value by way of the actuation of at least two adjusting members, wherein upon a deviation in the engine regulating value from a reference value the amount of gas fed to the internal combustion machine is altered by the actuation of the throttle device as the first adjusting member and by the variation in the geometry of the exhaust gas turbine as the second adjusting member so that the engine regulating value is re-set to the reference value.

2. A method as set forth in claim 1, wherein the internal combustion machine operates a generator or mechanical direct drive.

3. A method as set forth in claim 1, wherein the internal combustion machine is regulated to a constant rotary speed.

4. A method as set forth in claim 1, wherein the internal combustion machine is regulated to a constant output power.

5. A method as set forth in claim 1, wherein the geometry of the exhaust gas turbine is altered only upon a regulating deviation of the engine regulating value from the reference value of at least 5%.

6. A method as set forth in claim 1, wherein the gas flowing to the throttle device is cooled.

7. A method as set forth in claim 1, wherein the gas fed to the compressor device is a fuel/air mixture.

8. A regulating device for a stationary internal combustion machine comprising a compressor device operable by way of an exhaust gas turbine of variable geometry and a throttle device which regulates an engine regulating value to a substantially constant reference value, wherein at least two adjusting members can be influenced by way of the regulating device, wherein there is provided a first adjusting member for varying the position of the throttle device and that there is provided a second adjusting member for varying the geometry of the exhaust gas turbine, wherein in the operating state upon a regulating deviation of the engine regulating value from the reference value the amount of gas fed to the internal combustion machine can be regulated by way of the regulating device by the position of the throttle device as the first adjusting member and the geometry of the exhaust gas turbine as the second adjusting member being variable.

9. A regulating device as set forth in claim 8, wherein the engine regulating value is the power or the rotary speed.

10. A regulating device as set forth in claim 8, wherein the regulating device is so designed that the change in the geometry of the exhaust gas turbine is effected in subordinate relationship.

11. A regulating device as set forth in claim 8, wherein a respective regulator is associated with the two adjusting values.

12. A regulating device as set forth in claim 11, wherein the at least two regulators are so designed that the change in the geometry of the exhaust gas turbine is delayed in relation to the influencing of the position of the throttle device.

13. A regulating device as set forth in claim 8, wherein the regulating device is so designed that it actuates only the throttle device upon a deviation of the engine regulating value of below 5% from the reference value.

14. A regulating device as set forth in claim 8, wherein the regulating device is so designed that it influences both adjusting values upon a deviation of the regulating value of at least 5% from the reference value.

15. A regulating device as set forth in claim 8, wherein the regulating device has at least one PID-regulator.

16. A regulating device as set forth in claim 8, wherein an adjusting value limitation is associated with the regulating device so that the actuation of at least one adjusting member is limited in such a way that the amount of gas fed to the internal combustion machine does not exceed a preferably predeterminable maximum value.

17. A regulating device as set forth in claim 8, wherein at least one regulator has a dead band for delaying the change in the adjusting member.

18. A regulating device as set forth in claim 17, wherein the dead band is so designed that it permits a deviation in the regulating value from the reference value of up to 5%.

19. A stationary internal combustion machine comprising a compressor device for compressing gas fed to the engine and a throttle device connected downstream of the compressor device for limiting the amount of compressed gas fed to the internal combustion machine, wherein the compressor device is operable by way of an exhaust gas turbine of variable turbine geometry, the internal combustion machine further comprising a regulating device which in the operating state regulates the internal combustion machine to a substantially constant engine regulating value by way of the variation of at least two adjusting members, by the regulating device actuating the throttle device as a first adjusting member and varying the geometry of the exhaust gas turbine as a second adjusting member.

20. An internal combustion machine as set forth in claim 19, wherein the engine regulating value is a constant rotary speed of the internal combustion machine.

21. An internal combustion machine as set forth in claim 19, wherein the engine regulating value is a constant output power of the internal combustion machine.

22. An internal combustion machine as set forth in claim 19, wherein disposed between the compressor device and the throttle device is a cooling device with which the gas flowing to the throttle device can be cooled.

23. An internal combustion machine as set forth in claim 19, wherein connected upstream of the compressor device is a mixing device in which fuel and air can be mixed.

24. A generator having an internal combustion machine as set forth in claim 19.
